(19) United States
(12) Patent Application Publication
(10) Pub. No.: US 2025/0298668 A1
(43) Pub. Date: Sep. 25, 2025

(54) METHOD OF TASK EXECUTING, ELECTRONIC DEVICE, AND STORAGE MEDIUM

(71) Applicants: DOUYIN VISION CO., LTD., Beijing (CN); Beijing Zitiao Network Technology Co., Ltd., Beijing (CN)

(72) Inventors: Ning WANG, Beijing (CN); Meizhen LI, Beijing (CN); Wenjun DING, Beijing (CN); Jia HE, Beijing (CN); Ruokun PU, Beijing (CN); Xiang ZHANG, Beijing (CN); Min KE, Beijing (CN)

(21) Appl. No.: 18/983,359

(22) Filed: Dec. 17, 2024

(30) Foreign Application Priority Data
Mar. 19, 2024 (CN) 202410317082.6

(51) Int. Cl. G06F 9/50

(52) U.S. Cl. CPC G06F 9/5038

(57) ABSTRACT

Embodiments of the present disclosure provide a method of task executing, an electronic device, and a storage medium. Requirement text based on a natural language is obtained, the requirement text being used to describe a target operation and maintenance task; the requirement text is processed by an operation and maintenance processing model, to generate a task processing link, which provides at least one link node and a corresponding agent object, the link node being used to represent a processing step for the target operation and maintenance task, and the agent object being used to execute a processing step represented by the corresponding link node; and the task processing link is executed to generate a task execution result of the target operation and maintenance task.

### CROSS-REFERENCE TO RELATED APPLICATION

The present disclosure claims priority of the Chinese Patent Application No. 202410317082.6 filed on Mar. 19, 2024, the disclosure of which is incorporated herein by reference in its entirety as part of the present application.

### TECHNICAL FIELD

Embodiments of the present disclosure relate to, a method of task executing, an electronic device, and a storage medium.

### BACKGROUND

Currently, technical solutions for deploying applications and services based on cloud services have been increasingly widely used due to their features of flexibility, convenience, and low costs. Various cloud service providers and users manage and maintain, by a cloud computing platform, services, components, and software and hardware devices carried by the cloud computing platform.

For operation and maintenance tasks such as anomaly detection and data display executed by the cloud computing platform, cloud computing platform users usually execute corresponding operation and maintenance tasks by writing specific code scripts and functional modules.

### SUMMARY

An embodiment of the present disclosure provides a method of task executing, including: obtaining a requirement text based on natural language, where the requirement text is used to describe a target operation and maintenance task; processing the requirement text by an operation and maintenance processing model, to generate a task processing link, which provides at least one link node and a corresponding agent object, where the link node is used to represent a processing step for the target operation and maintenance task, the agent object is used to execute a processing step represented by the corresponding link node, and the operation and maintenance processing model supports natural language-based interaction, so as to execute a natural language processing task, and supports scheduling of one or more of a plurality of agent objects pre-configured in an operation and maintenance scenario based on the task, so as to control the scheduled agent objects to cooperatively complete a task instruction; and executing the task processing link, to generate a task execution result of the target operation and maintenance task.

An embodiment of the present disclosure provides an apparatus of task executing, including: an obtaining module, configured to obtain a requirement text based on natural language, where the requirement text is used to describe a target operation and maintenance task; a generation module, configured to process the requirement text by an operation and maintenance processing model, to generate a task processing link, which provides at least one link node and a corresponding agent object, where the link node is used to represent a processing step for the target operation and maintenance task, the agent object is used to execute a processing step represented by the corresponding link node, and the operation and maintenance processing model supports natural language-based interaction, so as to execute a natural language processing task, and supports scheduling of one or more of a plurality of agent objects pre-configured in an operation and maintenance scenario based on the task, so as to control the scheduled agent objects to cooperatively complete a task instruction; and a processing module, configured to execute the task processing link, to generate a task execution result of the target operation and maintenance task.

An embodiment of the present disclosure provides an electronic device, including: a processor and a memory, where the memory stores computer-executable instructions; and the processor executes the computer-executable instructions stored in the memory, to cause the at least one processor to perform the method of task executing according to the above and various possible designs of the above.

An embodiment of the present disclosure provides a computer-readable storage medium. The computer-readable storage medium stores computer-executable instructions that, when executed by a processor, cause the method of task executing according to the above and various possible designs of the above to be implemented.

An embodiment of the present disclosure provides a computer program product including a computer program that, when executed by a processor, causes the method of task executing according to the above and various possible designs of the above to be implemented.

### BRIEF DESCRIPTION OF DRAWINGS

In order to more clearly describe the technical solutions in the embodiments of the present disclosure, the accompanying drawings for describing the embodiments will be briefly described below. Apparently, the accompanying drawings in the description below show some embodiments of the present disclosure, and those of ordinary skill in the art may still derive other accompanying drawings from these accompanying drawings without creative efforts.

FIG. 1 is a diagram of an application scenario of a method of task executing according to an embodiment of the present disclosure;

FIG. 2 is a first schematic flowchart of a method of task executing according to an embodiment of the present disclosure;

FIG. 3 is a schematic diagram of an operation and maintenance processing model according to an embodiment of the present disclosure;

FIG. 4 is a flowchart of a specific implementation of step S102 in the embodiment shown in FIG. 2;

FIG. 5 is a schematic diagram of a process of generating a task processing link according to an embodiment of the present disclosure;

FIG. 6 is a flowchart of a specific implementation of step S1024 in the embodiment shown in FIG. 4;

FIG. 7 is a flowchart of a specific implementation of step S100B;

FIG. 8 is a schematic diagram of a process of executing an operation and maintenance task according to an embodiment of the present disclosure;

FIG. 9 is a second schematic flowchart of a method of task executing according to an embodiment of the present disclosure;

FIG. 10 is a flowchart of a possible implementation of step S203 in the embodiment shown in FIG. 9;

FIG. 11 is a schematic diagram of a process of generating a task processing link based on a main agent object according to an embodiment of the present disclosure;

FIG. 12 is a flowchart of another possible implementation of step S203 in the embodiment shown in FIG. 9;

FIG. 13 is a schematic diagram of determining a target processing step according to an embodiment of the present disclosure;

FIG. 14 is another schematic diagram of determining a target processing step according to an embodiment of the present disclosure;

FIG. 15 is a block diagram of a structure of an apparatus of task executing according to an embodiment of the present disclosure;

FIG. 16 is a schematic diagram of a structure of an electronic device according to an embodiment of the present disclosure; and

FIG. 17 is a schematic diagram of a hardware structure of an electronic device according to an embodiment of the present disclosure.

### DETAILED DESCRIPTION

To make the objectives, technical solutions and advantages of embodiments of the present disclosure clearer, the technical solutions in the embodiments of the present disclosure will be described clearly and completely below with reference to the accompanying drawings in the embodiments of the present disclosure. Apparently, the embodiments described are some rather than all of the embodiments of the present disclosure. Based on the embodiments of the present disclosure, all other embodiments obtained by those of ordinary skill in the art without creative efforts fall within the scope of protection of the present disclosure.

An application scenario of the embodiments of the present disclosure is described below.

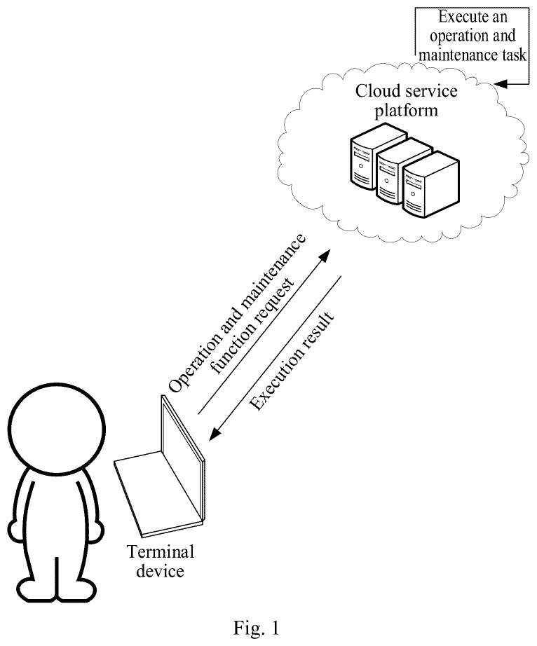

FIG. 1 is a diagram of an application scenario of a method of task executing according to an embodiment of the present disclosure. The method of task executing according to the embodiment of the present disclosure may be applied to an application scenario for operation and maintenance of a cloud service platform. Specifically, an executing body in this embodiment may be a server for running a cloud service platform, or another electronic device with a similar function. As shown in FIG. 1, taking a server as an example, when applications and services deployed in a cloud service platform need to maintained, a user-side terminal device may invoke, by sending an operation and maintenance function request to the server, different operation and maintenance functional models (modules) provided by the server (the cloud service platform), such as anomaly detection functional models, data detection functional models, report generation functional models, and other functional models to execute an operation and maintenance task, generate a corresponding execution result, and return the execution result to the terminal device for display, thus meeting operation and maintenance requirements of a user.

However, in order to implement specific operation and maintenance scenarios for specific components and services, the user needs to customize different operation and maintenance functional models in advance, and a specific process of implementing the operation and maintenance functional modules may require a plurality of functional steps, so that the user needs to design and control the specific process of implementing the operation and maintenance functional modules. As components and operation and maintenance scenarios are increasingly more and increasingly complex, efficiency in deployment and use of different operation and maintenance functional modules are increasingly lower, but costs of maintenance, adjustment and optimization, replacement and retraining of the operation and maintenance functional models are increasingly higher, which leads to the problems of low efficiency, poor effects and high costs in deployment and execution of operation and maintenance tasks.

An embodiment of the present disclosure provides a method of task executing to solve the above problems.

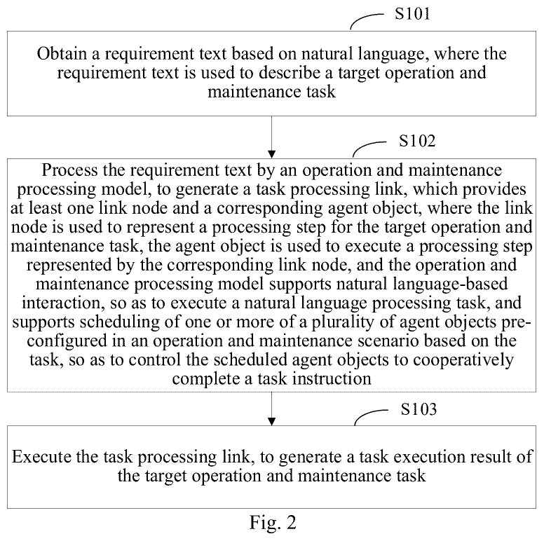

Referring to FIG. 2, FIG. 2 is a first schematic flowchart of a method of task executing according to an embodiment of the present disclosure. The method in this embodiment may be applied to an electronic device with computing power such as a server. The method of task executing includes:

Step S101: Obtain a requirement text based on natural language, where the requirement text is used to describe a target operation and maintenance task.

For example, referring to the schematic diagram of the application scenario shown in FIG. 1, taking the server as the executing body of the method in this embodiment as an example, a cloud computing platform or another platform for maintaining and managing the cloud computing platform runs in the server, and an operation and maintenance request instruction sent by a user-side terminal device to the server contains a requirement text, that is, a natural language-based text that describes the target operation and maintenance task and that is input by the user on the terminal device side. Specifically, the requirement text includes, for example, “Test a function A”. Then, the server obtains the requirement text by parsing the operation and maintenance request instruction. The above process of sending the requirement text by the terminal device to the server is only one possible implementation of obtaining the requirement text by the server. In another possible implementation, the server may alternatively obtain the requirement text in another way, such as another network device and another server, which is not specifically limited herein.

Step S102: Process the requirement text by an operation and maintenance processing model, to generate a task processing link, which provides at least one link node and a corresponding agent object, where the link node is used to represent a processing step for the target operation and maintenance task, the agent object is used to execute a processing step represented by the corresponding link node, and the operation and maintenance processing model supports natural language-based interaction, so as to execute a natural language processing task, and supports scheduling of one or more of a plurality of agent objects pre-configured in an operation and maintenance scenario based on the task, so as to control the scheduled agent objects to cooperatively complete a task instruction.

Step S103: Execute the task processing link, to generate a task execution result of the target operation and maintenance task.

For example, then, the server processes the requirement text, to obtain a corresponding task execution result. Specifically, an operation and maintenance processing model implemented based on a large language model (LLM) is deployed in the server. As an overall processing model or system, the operation and maintenance processing model can process an input parameter to output a corresponding output result. Specifically, the operation and maintenance processing model is implemented based on the large language model, and the large language model learns from huge and multi-type scenario data to obtain a general artificial intelligence capability with an outstanding generalization effect. With reference to private domain knowledge for different fields that is contained in agent objects, the operation and maintenance processing model can obtain professional knowledge and intelligent capability in a plurality of vertical fields. This is especially important for application scenarios of operation and maintenance of the cloud service platform, as the cloud service platform provides a plurality of different types of components and products, such as computing, storage, databases, and message queues. These components have different service logic, different architecture designs, and different functional modules, resulting in too high costs if different models are chosen in a component-by-component and scenario-by-scenario manner for intelligent operation and maintenance. The operation and maintenance processing model based on the large language model proposed in this embodiment fits this multi-field scenario well, and simplifies maintenance of a plurality of models to fine-tuning the same model (configuring agent objects) in a plurality of fields, thus greatly reducing the complexity caused by model diversity.

In the step of this embodiment, with the requirement text as an input parameter, after being input into the operation and maintenance processing model, the requirement text is processed by the operation and maintenance processing model to generate a task processing link. The task processing link is an output result. The task processing link is a type of data with a specific data format. The task processing link provides at least one link node and a corresponding agent object. The link node is used to represent a processing step for the target operation and maintenance task described in the requirement text, and the agent object is used to execute a processing step represented by the corresponding link node. Specifically, the agent object is a functional model that can receive an input, respond and then generate a corresponding output. The agent object may be generated based on specific and clear execution logic or may be obtained based on sample training. In the application scenario of operation and maintenance of the cloud service platform to which this embodiment is applied, the agent object may be a functional model for achieving functions such as anomaly detection, fault diagnosis, code generation, fault reporting, operation and maintenance visualization, and knowledge question and answer. The agent object is preset in the operation and maintenance processing model and has a specific target format that matches the operation and maintenance processing model, and therefore the operation and maintenance processing model can perceive, understand and invoke functions of the agent object. In a possible implementation, one or more orderly arranged link nodes and agent objects corresponding to the link nodes are recorded in the task processing link. After obtaining the task processing link, the server sequentially invokes the corresponding agent objects according to an execution order indicated by the task processing link based on the information provided by the task processing link, so that the target operation and maintenance task can be completed, to obtain the task execution result of the target operation and maintenance task.

The operation and maintenance processing model supports natural language-based interaction, so as to execute a natural language processing task, and supports scheduling of one or more of a plurality of agent objects pre-configured in an operation and maintenance scenario based on the task, so as to control the scheduled agent objects to cooperatively complete a task instruction. This sentence means that the operation and maintenance processing model may understand the requirement text based on natural language that is input by the user, and respond to execute a task described in the requirement text, such as an anomaly detection task, a data search task, or a report generation task. During execution of the task, for the executed step, the operation and maintenance processing model may invoke one or more of the plurality of agent objects pre-configured in a current operation and maintenance scenario, that is, the agent objects corresponding to the link node in the task processing link, that is, the step of determining the task processing link. Then, the task instruction may be completed in a mutually cooperative manner, that is, the operation and maintenance task described in the requirement text may be completed by means such as invoking the agent objects by the operation and maintenance processing model or invoking agent objects by agents.

More specifically, for example, in an anomaly detection task (an operation and maintenance scenario), the operation and maintenance processing model invokes an agent object Agent_1 and an agent object Agent_2 to execute corresponding task steps, to complete the task. In a report generation task (another operation and maintenance scenario), the task processing model invokes the agent object Agent_1 and the agent object Agent_2 to execute corresponding task steps, and after the agent object Agent_2 interacts with the agent object Agent_1, the agent object Agent_2 invokes an agent object Agent_3 to execute the corresponding task steps, to finally complete the task.

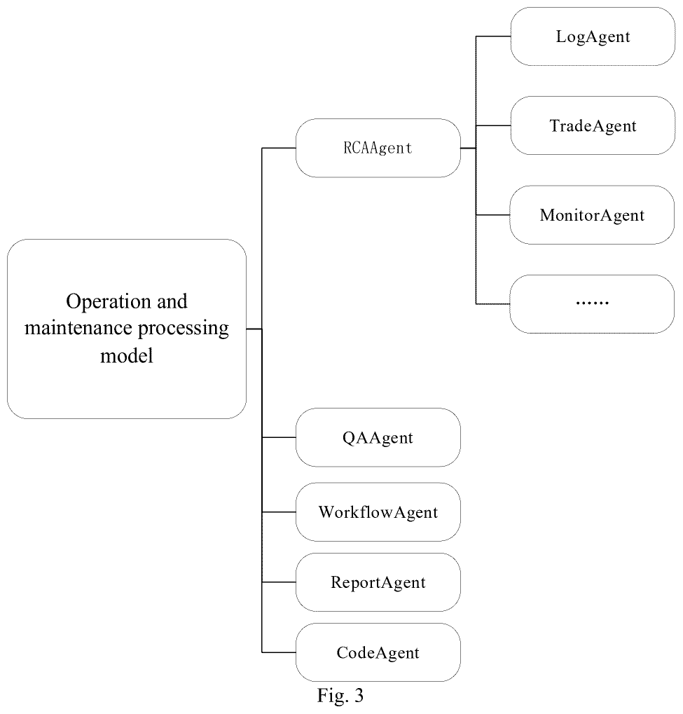

FIG. 3 is a schematic diagram of an operation and maintenance processing model according to an embodiment of the present disclosure. As shown in FIG. 3, the operation and maintenance processing model is configured for intent recognition, parameter extraction, and assignment of task scheduling work to appropriate agent objects. The agent objects are classified based on functions, and include multi-source data agents (shown as RCAAgent in the figure). The multi-source data agents are further divided into a plurality of subclasses, such as log data agent objects (LogAgent), trade data agent objects (TradeAgent), and monitoring data agent objects (MonitorAgent). The agent objects further include functional agent objects, such as question and answer functional agent objects (QAAgent), workflow planning agent objects (WorkflowAgent), report generation agent objects (ReportAgent), and code generation agent objects (CodeAgent). The operation and maintenance processing model generates and executes the task processing link by invoking the above agent objects, so as to finally obtain the task execution result.

In another possible implementation, with the requirement text as an input parameter, after being input into the operation and maintenance processing model, the requirement text is processed by the operation and maintenance processing model, to generate a task processing link, and then or at the same time, the task processing link is executed by the operation and maintenance processing model, that is, the agent objects in the task processing link are sequentially invoked according to an execution order of the agent objects, so as to obtain the task execution result. The task execution result is the output result of the operation and maintenance processing model.

Further, in a possible implementation, a large language model and a plurality of preset agent objects are provided in the operation and maintenance processing model, and the agent objects are implemented based on the same target format, so that the operation and maintenance processing model can recognize functions of the agent objects, and then invoke the agent objects to execute corresponding functions and steps.

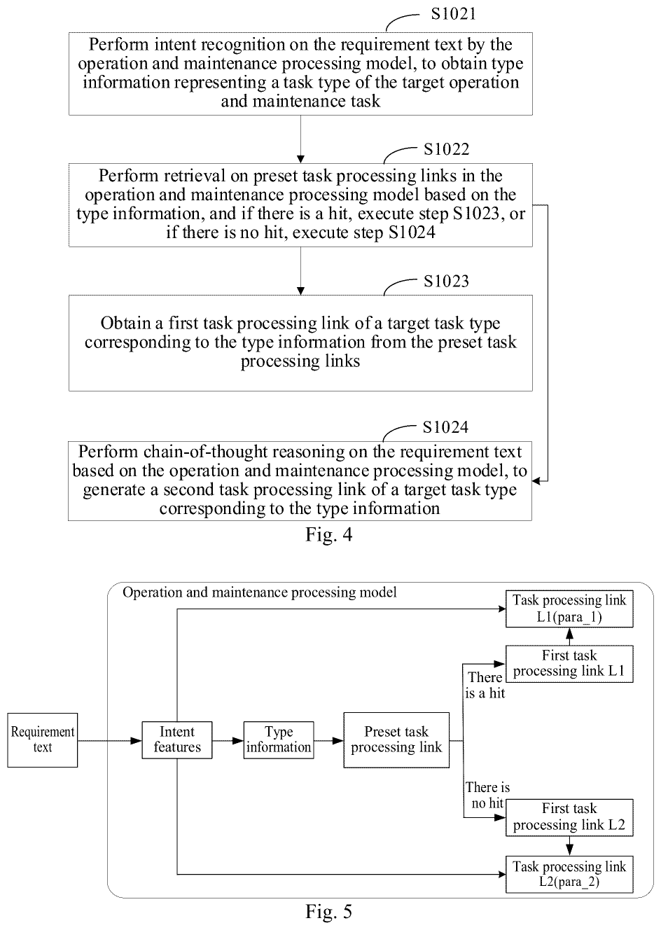

In a possible implementation, as shown in FIG. 4, a possible implementation of step S102 includes:

Step S1021: Perform intent recognition on the requirement text by the operation and maintenance processing model, to obtain type information representing a task type of the target operation and maintenance task.

Step S1022: Perform retrieval on preset task processing links in the operation and maintenance processing model based on the type information, and if there is a hit, execute step S1023, or if there is no hit, execute step S1024.

Step S1023: Obtain a first task processing link of a target task type corresponding to the type information from the preset task processing links.

Step S1024: Perform chain-of-thought reasoning on the requirement text based on the operation and maintenance processing model, to generate a second task processing link of a target task type corresponding to the type information.

For example, after the requirement text is input into the operation and maintenance processing model, intent recognition is performed on the requirement text by the operation and maintenance processing model. Specifically, for example, the requirement text is subjected to feature conversion, to obtain feature vectors, which are processed and then classified to obtain type information representing the task type of the target operation and maintenance task. The task type includes, for example, data processing tasks, anomaly detection tasks, and display tasks. Each of the above tasks may be further divided into a plurality of subtask types. A specific implementation may be set as required. In another implementation, the type information may also be a set of feature values expressed in the form of a vector, a matrix, etc., so that the type information can express a more accurate task type, and details are not described.

After the type information is obtained, retrieval is performed on existing task processing links preset in the operation and maintenance processing model based on the type information. There is a fixed mapping relationship between the type information and the task processing links preset in the operation and maintenance processing model, such as one-to-one mapping between the type information and the task processing links. Therefore, after the type information is obtained, through retrieval by using the capability of the operation and maintenance processing model (the above mapping relationship stored in the operation and maintenance processing model), it can be determined whether there is a task processing link in the operation and maintenance processing model that is used to process the operation and maintenance task (the target operation and maintenance task) of the target task type corresponding to the type information. Then, if there is a hit, that is, if there is a task processing link for processing the operation and maintenance task of the target task type in the operation and maintenance processing model, the hit task processing link (i.e. the first task processing link) is obtained. The first task processing link is equivalent to memory data in the operation and maintenance processing model, and may be previously generated by the operation and maintenance processing model or preset by the user. Then, based on the first task processing link, the execution of the target operation and maintenance task is completed.

In addition, if there is no hit, that is, if there is no task processing link for processing the operation and maintenance task of the target task type in the operation and maintenance processing model, the task processing link cannot be directly obtained from the operation and maintenance processing model. In this case, chain-of-thought (COT) reasoning is performed on the requirement text by using the reasoning capability of the operation and maintenance processing model, to generate a task processing link matching the operation and maintenance task of the above target task type, that is, the second task processing link. Then, for example, after the second task processing link is successfully executed, to obtain the task execution result, the second task processing link is stored in the operation and maintenance processing model, to generate the above memory data.

In the step of this embodiment, the operation and maintenance processing model first performs memory data retrieval after performing intent recognition on the requirement text, and if there is a first task processing link matching the target task type, the first task processing link is directly read and executed, to obtain a task execution result, thus improving the efficiency and speed of executing the target operation and maintenance task. In addition, if there is no first task processing link matching the task type, a second task processing link matching the target task type is regenerated by using the capability of the operation and maintenance processing model, thus improving the generalization processing capability of the operation and maintenance processing model and improving the effect of executing the task execution result.

Further, in addition, the operation and maintenance processing model may further generate an execution parameter of each processing step after performing intent recognition on the requirement text, and configure, through the execution parameter, the first task processing link or second task processing link generated in the above step, and finally the first task processing link or the second task processing link configured with the execution parameter is used as the final task processing link. The execution parameter is a parameter used to determine a specific execution manner of the processing step. For example, in a “file detection” step, a corresponding execution parameter is used to indicate a target item specifically detected in the “file detection” step. More specifically, for example, the execution parameter is “*.exe”, which represents that a file with a file name suffix “*.exe” is detected when the “file detection” step is executed. Then, the final task processing link is executed, to generate a task execution result of the target operation and maintenance task.

Correspondingly, in a possible implementation, step S103 includes the following specific processing steps.

Step S1031: Obtain an execution order corresponding to invoking target agent objects corresponding to link nodes based on the task processing link.

Step S1032: Based on the execution order, invoke the corresponding target agent objects with corresponding execution parameters as inputs in sequence to obtain the execution result of the target operation and maintenance task.

For example, in a possible implementation, the task processing link obtained by the above step contains an execution parameter, so that when the task processing link is executed, processing steps corresponding to link nodes in the task processing link are executed based on the execution parameter, and thus the execution result of the target operation and maintenance task can be obtained. In another possible implementation, execution parameters may be fixed values in a one-to-one correspondence with processing steps and agent objects, that is, after the task processing link (processing steps or the target agent objects in the task processing link) is determined, the execution parameters required for each target agent object to execute the processing steps are determined. Then, based on the execution order, corresponding target agent objects are invoked to execute corresponding processing steps with the execution parameters as inputs, so that the execution process of the target operation and maintenance task can be completed.

Optionally, after step S1024, the method further includes:

Step S1025: Perform intent recognition on the requirement text by the operation and maintenance processing model, to obtain node information corresponding to at least one target link node, where the target link node is a link node in the first task processing link or the second task processing link, and the node information is used to represent an execution parameter of a processing step corresponding to the target link node.

Step S1026: Configure the first task processing link or the second task processing link based on the node information, to generate the task processing link.

FIG. 5 is a schematic diagram of a process of generating a task processing link according to an embodiment of the present disclosure. As shown in FIG. 5, an operation and maintenance processing model extracts features from requirement text to obtain intent features, and generates type information representing a task type of a target operation and maintenance task based on the intent features. Then the operation and maintenance processing model performs retrieval on task processing links preset in the operation and maintenance processing model based on the type information. If there is a hit, a first task processing link L1 of a target task type corresponding to the type information is obtained from the preset task processing link, or if there is no hit, chain-of-thought reasoning is performed on the requirement text, to generate a second task processing link L2 of the target task type corresponding to the type information. Then, the operation and maintenance processing model generates node information para corresponding to at least one target link node based on the intent features. The target link node is a link node in the first task processing link L1 or the second task processing link L2, and the node information is used to represent an execution parameter of a processing step corresponding to the target link node. Then, based on the node information, the first task processing link L1 or the second task processing link L2 is configured to generate a task processing link correspondingly configured with an execution parameter. For example, as shown in the figure, node information corresponding to the first task processing link L1 is para_1; and node information corresponding to the second task processing link L2 is para_2. After the first task processing link L1 or the second task processing link L2 is configured, a finally generated task processing link is a task processing link L1 (para_1) or a task processing link L2 (para_2).

In the step of this embodiment, link nodes and corresponding node information are determined by performing intent recognition on the requirement text, so that the configuration of an execution parameter of a processing step corresponding to a target link node on each task processing link is implemented, and further detailed configuration of the task processing link is implemented, so that a more complex operation and maintenance task can be achieved based on the task processing link.

Further, when the first task processing link is hit based on the target task type, the existing first task processing link can be directly read by the operation and maintenance processing model, and then a required task processing link can be generated. In the case of no hit, a new task processing link, namely the second task processing link, needs to be generated by chain-of-thought reasoning. The process of generating the second task processing link is further described below.

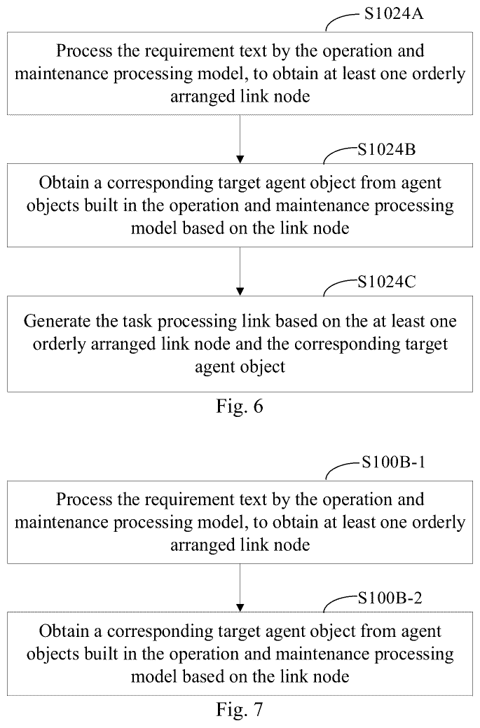

For example, as shown in FIG. 6, a specific implementation of step S1024 includes:

Step S1024A: Process the requirement text by the operation and maintenance processing model, to obtain at least one orderly arranged link node.

Step S1024B: Obtain a corresponding target agent object from agent objects built in the operation and maintenance processing model based on the link node.

Step S1024C: Generate the task processing link based on the at least one orderly arranged link node and the corresponding target agent object.

For example, first, the requirement text is understood by the operation and maintenance processing model based on the large language model, to determine processing steps of the target operation and maintenance task. In a possible implementation, processing steps of the target operation and maintenance task are static, that is, all processing steps of the target operation and maintenance task are determined at one time. For example, the target operation and maintenance task described in the requirement text is an “anomaly detection task”. Correspondingly, after the requirement text is recognized by the operation and maintenance processing model, generating the “anomaly detection task” includes three steps, that is:
a step A: data screening; a step B: feature value comparison; and a step C: generation of a test report. A trained operation and maintenance processing model has the capability to map the “anomaly detection task” into the above three ordered steps, and content of the above three steps is only exemplary. A specific implementation and specific definitions of the above three steps determined by the operation and maintenance processing model based on the “anomaly detection task” are not described herein.

Then, each step corresponds to one link node. After determining the above three ordered link nodes, the operation and maintenance processing model further determines agent objects corresponding to the link nodes, that is, objects that execute the corresponding processing steps. Based on the previous description, the agent objects are data preset in the operation and maintenance processing model based on a unified target format, so the operation and maintenance processing model can perceive and understand functions of each agent object, and then, based on the processing steps corresponding to the above link nodes, a matching target agent object is determined from all agent objects. Then, the task processing link can be obtained by combining node data in the form of data pairs including the link nodes and the agent objects.

In another possible implementation, processing steps of the target operation and maintenance task are dynamically determined, that is, a next processing step is determined based on a step execution result of a previous processing step. For example, taking the above “anomaly detection task” as an example, after the requirement text is recognized by the operation and maintenance processing model, a first processing step corresponding to the “anomaly detection task” is generated, which is a step A of data screening. Then, the processing step A is executed by the agent object for obtaining the step A (step S1024B), and a next processing step is determined based on an execution result of the step A. For example, a step execution result obtained after data screening includes a number of files, and if the number of files is less than a number threshold, a processing step B of feature value comparison is executed, or if the number of files is greater than the number threshold, a processing step D of data filtering is executed. The rest can be done in the same manner, until the last processing step is determined, so that the task processing link can be obtained. In this embodiment, the processing steps of the target operation and maintenance task are dynamically determined, so that the purpose of executing a more complex operation and maintenance task can be achieved, and performance of executing various tasks can be improved.

Further, in a possible implementation, a specific implementation of step S1024B includes:

Step S1024B-1: Determine a corresponding agent function type based on a processing step corresponding to the link node.

Step S1024B-2: Obtain, based on the agent function type, the target agent object built in the operation and maintenance processing model.

For agent function types specifically corresponding to different agent objects, the operation and maintenance processing model can perceive an agent function type of each preset agent object, and for example, determine the type by means of an object name of the agent object. Therefore, a corresponding target agent object can be determined by a mapping relationship between a processing step and an agent function type. In the step of this embodiment, a target agent object matching a link node is determined by a mapping relationship between an agent function type and a processing step, so that a specific function of the determined target agent object matches the processing step, thereby improving an execution success rate of the processing step corresponding to the link node, shortening a total execution time of each processing step, and improving efficiency in executing the target operation and maintenance task.

Further, optionally, before the above step, the method further includes a process of configuring agent objects preset in the operation and maintenance processing model, specifically further including:

Step S100A: Receive a first user instruction, where the first user instruction is used to set a function implemented by an agent object during execution of a processing step for the target operation and maintenance task.

Step S100B: Configure the agent object in the operation and maintenance processing model based on the first user instruction, where the operation and maintenance processing model is used to invoke the configured agent object to generate the task processing link.

For example, in order to enable the operation and maintenance processing model to accurately understand functions and effects of agent objects, and make full use of the advantages of each agent object, to generate a reasonable and efficient task processing link, an agent object needs to be pre-configured in the operation and maintenance processing model. A function design process of the agent object can be executed by a user-side terminal device. Specifically, the terminal device sends a first user instruction to a server to set a function implemented by the agent object during execution of a processing step for the target operation and maintenance task. For example, the first user instruction includes, for example, a descriptive statement based on a natural language and used to describe the achieved function, for example, “Query data XX with a specific timestamp”. Then, the server automatically generates a corresponding agent object based on the received first user instruction and configures the agent object in the operation and maintenance processing model, so that when the target operation and maintenance task can be subsequently processed, a corresponding task processing link can be constructed and executed by invoking the agent object, thereby completing automatic generation and execution of the target operation and maintenance task.

Further, for example, as shown in FIG. 7, a specific implementation of step S100B includes:

Step S100B-1: Obtain a configuration template based on a target format, where the target format corresponds to a training sample of the operation and maintenance processing model.

Step S100B-2: Set the configuration template based on the first user instruction, to generate agent description information, and input the agent description information into the operation and maintenance processing model, to configure the agent object in the operation and maintenance processing model.

For example, during configuration of the agent object, the configuration may be based on the configuration template of the target format, and the target format corresponds to the training sample of the operation and maintenance processing model, so that the operation and maintenance processing model can understand content in the configuration template, and then functions, capabilities and characteristics of the agent object generated by the operation and maintenance processing model are more accurate. In addition, because the agent object generated by the operation and maintenance processing model has accurate functions, the operation and maintenance processing model has a better understanding to the agent object, so that when a task processing link is constructed, a more reasonable target agent object can be invoked, thus reducing interaction rounds between agent objects and improving efficiency and accuracy of generating the task processing link.

Certainly, in another possible implementation, in addition to implementing the above process based on the operation and maintenance processing model, the processor may alternatively be implemented by executing a code script, and content in the code script is an execution process of the above steps. This implementation is not described in detail herein.

In the steps of this embodiment, requirement text based on a natural language is obtained, where the requirement text is used to describe a target operation and maintenance task; the requirement text is processed by an operation and maintenance processing model, to generate a task processing link, which provides at least one link node and a corresponding agent object, where the link node is used to represent a processing step for the target operation and maintenance task, and the agent object is used to execute a processing step represented by the corresponding link node; and the task processing link is executed, to generate a task execution result of the target operation and maintenance task. The requirement text input by a user is converted into the task processing link, and the task processing link is used to indicate a task processing step and a corresponding execution object of the target operation and maintenance task. The task processing link is executed to automatically execute the target operation and maintenance task, without setting a specific process of executing the target operation and maintenance task, thereby improving efficiency in deployment and execution of the operation and maintenance task and improving a task execution effect.

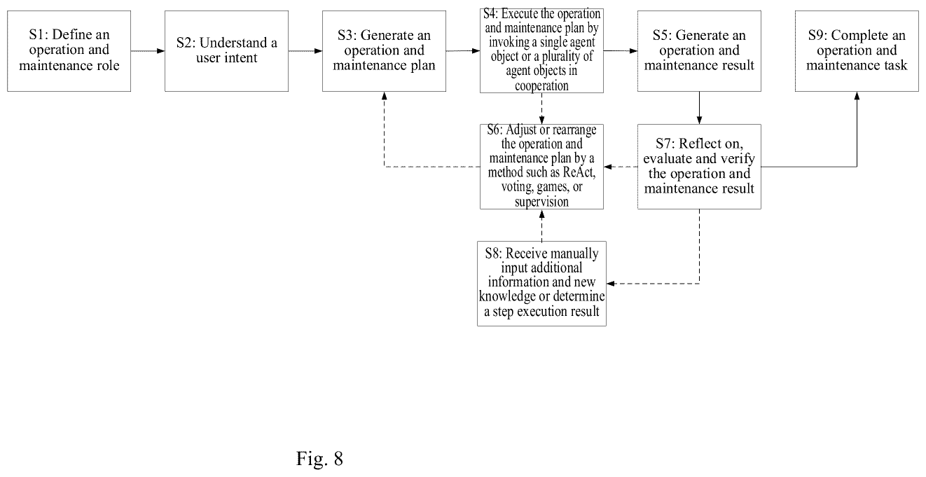

FIG. 8 is a schematic diagram of a process of executing an operation and maintenance task according to an embodiment of the present disclosure. With reference to FIG. 8, with a more specific embodiment, an execution process of a method in this embodiment is described. As shown in FIG. 8, for example, based on a user instruction, a server first executes step S1 of defining an operation and maintenance role. Then, based on a requirement text input by a user, step S2 of understanding a user intent is executed. Then, step S3 of generating an operation and maintenance plan is executed. That is, a task processing link is generated. Then, based on the operation and maintenance plan, step S4 of executing the operation and maintenance plan by invoking a single agent object or a plurality of agent objects in cooperation is executed. After step S4, based on a specific execution condition, step S5 of generating an operation and maintenance result may be executed. In addition, step S6 of adjusting or rearranging the operation and maintenance plan by a method such as ReAct, voting, games, or supervision may be executed, and step S3 may be executed again. After step S5, step S7 of reflecting on, evaluating and verifying the operation and maintenance result is executed. Based on an execution result of step S7, step S6 is executed again, or step S8 of receiving manually entered additional information and new knowledge or determining a step execution result is executed, or step S9 of completing an operation and maintenance task is executed.

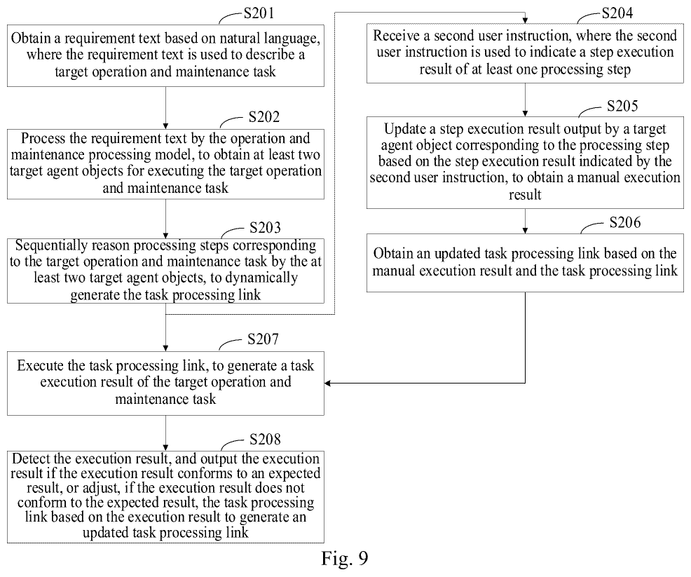

Referring to FIG. 9, FIG. 9 is a second schematic flowchart of a method of task executing according to an embodiment of the present disclosure. On the basis of the embodiment shown in FIG. 2, this embodiment further refines step S102. The method of task executing includes:

Step S201: Obtain a requirement text based on natural language, where the requirement text is used to describe a target operation and maintenance task.

Step S202: Process the requirement text by the operation and maintenance processing model, to obtain at least two target agent objects for executing the target operation and maintenance task.

Step S203: Sequentially reason processing steps corresponding to the target operation and maintenance task by the at least two target agent objects, to dynamically generate the task processing link.

For example, in the case of dynamically generating the task processing link, in this embodiment, after performing intent recognition on the requirement text based on the natural language, the operation and maintenance processing model first determines at least two target agent objects for executing the target operation and maintenance task, and then uses the target agent objects determined in this step for reasoning, that is, uses a step execution result of the current processing step to determine subsequent processing steps until a last processing step or a preset end condition is reached, thereby dynamically generating the task processing link. Compared with the solution of dynamically determining a corresponding task processing link by the operation and maintenance processing model itself (that is, the solution in the embodiment shown in FIG. 2), the personalized capability and private domain knowledge of the agent objects can be fully utilized, thus improving accuracy of the generated task processing link.

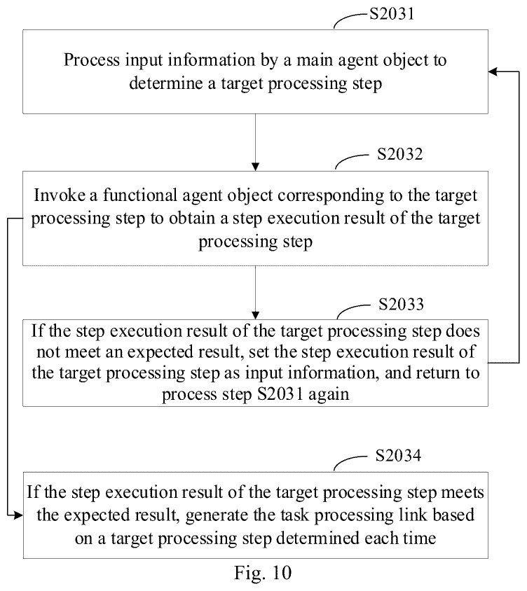

In a possible implementation, the at least two target agent objects include a main agent object and at least one functional agent object corresponding to the target operation and maintenance task. As shown in FIG. 10, a possible implementation of step S203 includes:

Step S2031: Process input information by the main agent object to determine a target processing step.

Step S2032: Invoke a functional agent object corresponding to the target processing step to obtain a step execution result of the target processing step.

Step S2033: If the step execution result of the target processing step does not meet an expected result, set the step execution result of the target processing step as input information, and return to process step S2031.

Step S2034: If the step execution result of the target processing step meets the expected result, generate the task processing link based on a target processing step determined each time.

For example, in the step of this embodiment, a solution of reasoning based on centralized agent objects to generate the task processing link is provided. Specifically, the task processing link first determines a main agent object by performing intent recognition on the requirement text, and then determines a target processing step by the main agent object and input information input to the main agent object. Initialized input information may be a fixed value or determined based on an intent recognition result. Then, a functional agent object corresponding to the target processing step (there is a fixed mapping relationship between the processing step and the functional agent object executing the processing step) is invoked to execute the target processing step, to obtain a step execution result. Then, the functional agent object returns the step execution result to the main agent object, and the main agent object determines whether a current step execution result meets the expected result. If not, with the current step execution result as input information, the main agent object re-determines a target processing step, that is, return to execute step S2031, and so on until the step execution result of the target processing step meets the expected result, and the task processing link is generated based on the target processing step determined in each cycle. Because each link node has been executed during dynamic determining of the task processing link, after the task processing link is dynamically generated in this way, correspondingly, the step execution result corresponding to the last link node of the task processing link, that is, the task execution result, can be obtained.

The main agent object may be a functional module that is good at achieving a specific function and executing a specific task, while the functional agent object may be understood as a non-main agent object, that is, a general agent object in the target agent objects. Because the main agent object dominates distribution and execution of processing steps, the personalized function and private domain knowledge of the main agent object are fully utilized to achieve a better processing effect, thereby improving accuracy and generation efficiency of the generated task processing link and the final task execution result.

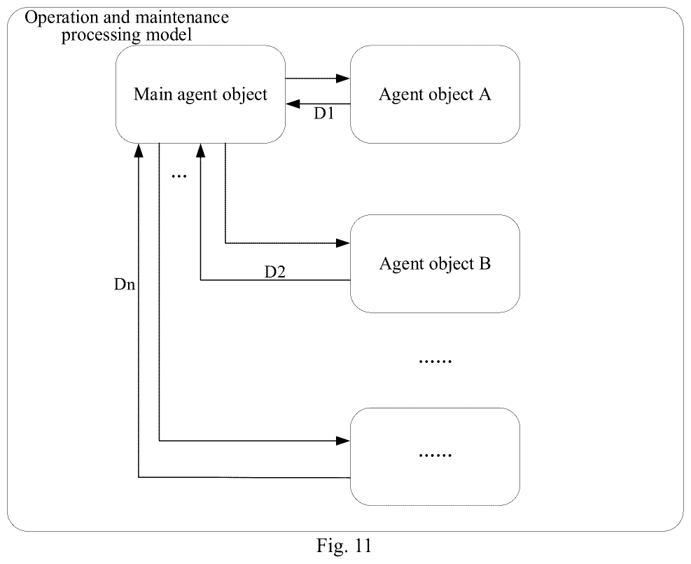

FIG. 11 is a schematic diagram of a process of generating a task processing link based on a main agent object according to an embodiment of the present disclosure. As shown in FIG. 11, the main agent object determines functional agent objects. For example, the main agent object first determines an agent object A (corresponding to a processing step a), and a step execution result D1 generated after the agent object A is invoked is returned to the main agent object; then the main agent object determines an agent object B (corresponding to a processing step b), and a step execution result D2 generated after the agent object B is invoked is returned to the main agent object, and so on until the main agent object obtains a step execution result Dn that meets an expected condition; and then the cyclic process ends and a task processing link is generated.

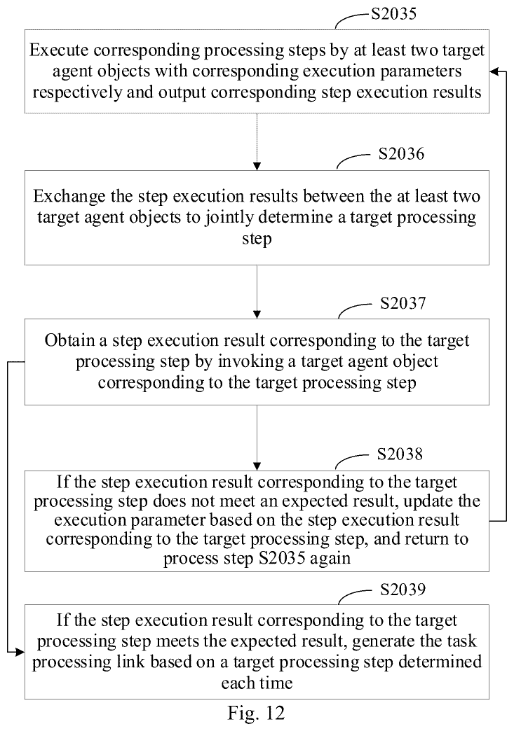

In another possible implementation, as shown in FIG. 12, a possible implementation of step S203 includes:

Step S2035: Execute corresponding processing steps by the at least two target agent objects with corresponding execution parameters respectively and output corresponding step execution results.

Step S2036: Exchange the step execution results between the at least two target agent objects to jointly determine a target processing step.

Step S2037: Obtain a step execution result corresponding to the target processing step by invoking a target agent object corresponding to the target processing step.

Step S2038: If the step execution result corresponding to the target processing step does not meet an expected result, update the execution parameter based on the step execution result corresponding to the target processing step, and return to process step S2035.

Step S2039: If the step execution result corresponding to the target processing step meets the expected result, generate the task processing link based on a target processing step determined each time.

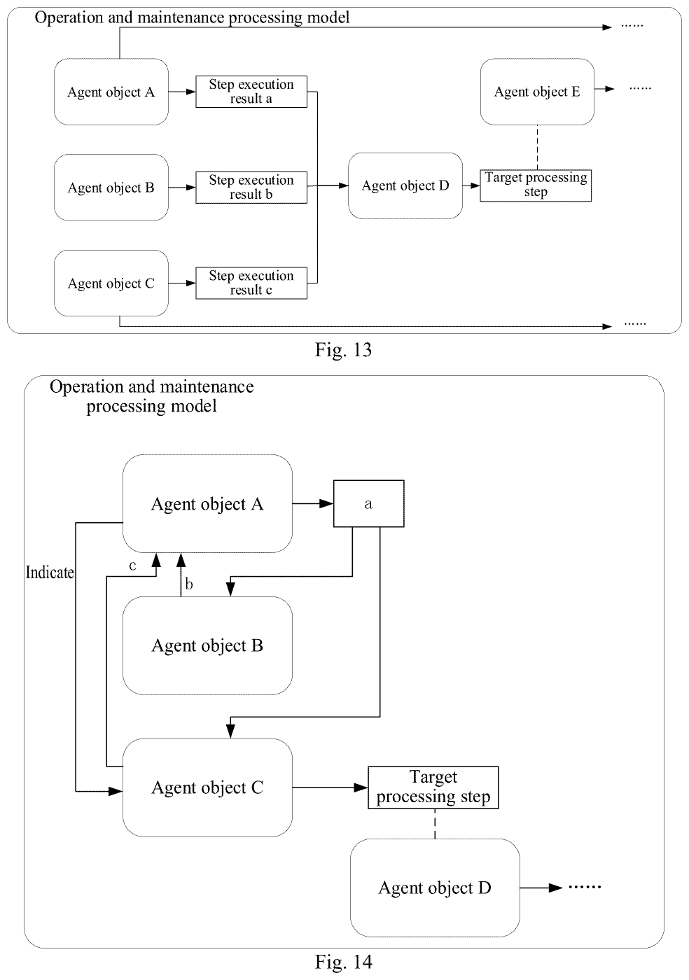

For example, in another embodiment of this embodiment, the implementation of step S203 may be to invoke at least two target agent objects for information interaction, to determine the task processing link. Specifically, at least two target agent objects are first determined based on the requirement text, and the specific implementation has been described in the previous embodiment, so details are not repeated herein. Then, the at least two target agents respectively execute corresponding processing steps, to obtain corresponding step execution results. In a possible implementation, the processing steps may be executed separately. FIG. 13 is a schematic diagram of determining a target processing step according to an embodiment of the present disclosure. As shown in FIG. 13, for example, an agent object A executes a corresponding processing step, to obtain a step execution result a; an agent object B executes a corresponding processing step, to obtain a step execution result b; and an agent object C executes a corresponding processing step, to obtain a step execution result c, and then an agent object D processes the above step execution results a, b and c, to obtain a corresponding next processing step, that is, a target processing step. Then, the target processing step is executed by a corresponding target agent object (such as an agent object E), to obtain a corresponding step execution result, and based on further interaction with other agent objects (such as the agent object A and the agent object C), similar above steps are repeated, to obtain a next execution step (the target processing step) until all the target processing steps are obtained. In this process, agent objects such as the agent object A, the agent object B, the agent object C, and the agent object D interact with each other. In another possible implementation, a next execution target may alternatively be determined among a plurality of agent objects through voting, games, etc. FIG. 14 is a schematic diagram of determining a target processing step according to an embodiment of the present disclosure. As shown in FIG. 14, for example, an agent object A executes a corresponding processing step, to obtain a step execution result a (shown as a in the figure), and then the execution result is sent to an agent object B. The agent object B obtains a corresponding step execution result b (shown as b in the figure) based on the step execution result a, and returns the step execution result b to the agent object A. Based on the step execution result b returned by the agent object B, the agent object A believes that the step execution result b does not meet an expectation, and thus sends the step execution result a again to an agent object C, and the agent object C obtains a corresponding step execution result c (shown as c in the figure) based on the step execution result a. The step execution result c contains description information (such as confidence) of the execution result, and description information of a corresponding target processing step. The step execution result c is returned to the agent object A, and then the agent object A compares the step execution result b with the step execution result c, and instructs one of the agent objects based on a comparison result, to determine a next execution step (that is, a target execution step). For example, after comparing the two step execution results, the agent object A instructs the agent object C corresponding to the execution result c to generate the target execution step, that is, the agent object C determines a next agent object D to be invoked. Then, the agent object D repeats the above steps, and executes interaction steps such as voting and games with other agent objects, and finally all target execution steps are obtained.

In the step of this embodiment, the next processing step is determined in a decentralized manner by interaction steps such as games and voting among a plurality of agent objects, so that the task processing link is dynamically generated, and the knowledge and capability of each agent object are fully utilized. Therefore, the generated task processing link is more reasonable, and the capability and performance of solving complex operation and maintenance tasks are improved.

Optionally, in addition, the method further includes:

Step S204: Receive a second user instruction, where the second user instruction is used to indicate a step execution result of at least one processing step.

Step S205: Update a step execution result output by a target agent object corresponding to the processing step based on the step execution result indicated by the second user instruction, to obtain a manual execution result.

For example, during execution of step S203, that is, during dynamic determining of the task processing link, a second user instruction input by the user may be further received, and the second user instruction is used to indicate a step execution result of at least one processing step, thereby implementing manual intervention in the task processing link generation process. For example, during determining of the task processing link, when the operation and maintenance processing model is processing a current processing step A, if a second user instruction described based on a natural language and input by the user is received, the operation and maintenance processing model preferentially recognizes the second user instruction to obtain a corresponding processing step (for example, processing step A) indicated by the second user instruction and a corresponding step execution result (step execution result a). Then, the operation and maintenance processing model interrupts the processing of the processing step A and takes the execution result a indicated by the second user instruction as the step execution result of the processing step A. Alternatively, if the processing step A generates a step execution result, such as a step execution result b, the execution result a indicated by the second user instruction overwrites the generated step execution result b, and the step execution result a indicated by the above second user instruction is the manual execution result.

Step S206: Obtain an updated task processing link based on the manual execution result and the task processing link.

Then, based on the manual execution result, the current task processing link is updated to obtain the updated task processing link. A specific implementation process of updating the task processing link may be similar to the process of generating the task processing link in a possible implementation. For details, reference may be made to the specific implementation method described in step S203, and details are note described herein. In another possible implementation, an alternative task processing link corresponding to the current task processing link may also be obtained. Specifically, during generation of task processing links, the operation and maintenance processing model recalls a plurality of task processing links, takes the task processing links with the highest confidence as the current task processing link, and executes the above steps. Then, after a task execution result is obtained, if the execution result does not meet the expectation, the task processing link with the second confidence, that is, the alternative task processing link, is obtained, thereby obtaining the updated task processing link.

It can be understood that steps S204-S206 are optional, and in other possible embodiments, subsequent step S207 may be executed after step S203.

Step S207: Execute the task processing link, to generate a task execution result of the target operation and maintenance task.

Step S208: Detect the execution result, and if the execution result conforms to an expected result, output the execution result, or if the execution result does not conform to the expected result, adjust the task processing link based on the execution result to generate an updated task processing link.

For example, after an execution result corresponding to the target operation and maintenance task is obtained, the execution result can be further determined. If the execution result does not meet the expectation, it is suspected that this may be caused by the unreasonable task processing link generated. In this case, the step of generating the task processing link is re-executed, that is, it returns to step S203. The above steps are repeated until an execution result that conforms to the expected result is obtained. A specific implementation process is similar to the process of obtaining an updated task processing link based on the manual execution result and the current task processing link in step S206. Through the steps of this embodiment, the execution result is reviewed, and reasonability of the generated task processing link is gradually improved in a plurality of cycles, thereby obtaining an accurate execution result and improving task execution performance.

In this embodiment, the implementations of steps S201 and S207 are the same as the implementations of steps S101 and S103 in the embodiment shown in FIG. 2 of the present disclosure, and details are not repeated herein.

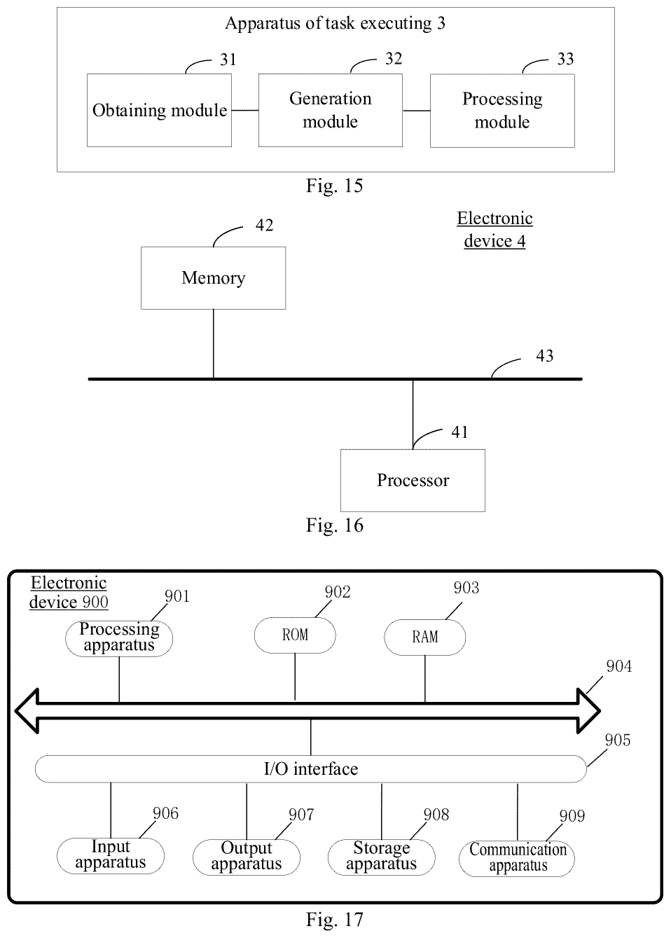

Corresponding to the method of task executing in the above embodiment, FIG. 15 is a block diagram of a structure of an apparatus of task executing according to an embodiment of the present disclosure. The method described in the above embodiment can be performed by the apparatus of task executing. The apparatus may be implemented by software and/or hardware and may be integrated into an electronic device with a certain data processing function. The electronic device may include, but is not limited to, a mobile terminal with a big data processing capability, and a fixed terminal with a big data processing capability such as a desktop computer and a supercomputer.

For ease of illustration, only parts related to the embodiment of the present disclosure are shown. Referring to FIG. 15, an apparatus of task executing 3 includes: an obtaining module 31, configured to obtain a requirement text based on natural language, where the requirement text is used to describe a target operation and maintenance task; a generation module 32, configured to process the requirement text by an operation and maintenance processing model, to generate a task processing link, which provides at least one link node and a corresponding agent object, where the link node is used to represent a processing step for the target operation and maintenance task, the agent object is used to execute a processing step represented by the corresponding link node, and the operation and maintenance processing model supports natural language-based interaction, so as to execute a natural language processing task, and supports scheduling of one or more of a plurality of agent objects pre-configured in an operation and maintenance scenario based on the task, so as to control the scheduled agent objects to cooperatively complete a task instruction; a processing module 33, configured to execute the task processing link, to generate a task execution result of the target operation and maintenance task.

According to one or more embodiments of the present disclosure, the generation module 32 is specifically configured to perform intent recognition on the requirement text by the operation and maintenance processing model, to obtain type information representing a task type of the target operation and maintenance task; perform retrieval on preset task processing links in the operation and maintenance processing model based on the type information; and obtain, if there is a hit, a first task processing link of a target task type corresponding to the type information from the preset task processing links, or perform, if there is no hit, chain-of-thought reasoning on the requirement text based on the operation and maintenance processing model, to generate a second task processing link of the target task type corresponding to the type information.

According to one or more embodiments of the present disclosure, the generation module 32 is further configured to perform intent recognition on the requirement text by the operation and maintenance processing model, to obtain node information corresponding to at least one target link node, where the target link node is a link node in the first task processing link or the second task processing link, and the node information is used to represent an execution parameter of a processing step corresponding to the target link node; and configure the first task processing link or the second task processing link based on the node information, to generate the task processing link.

According to one or more embodiments of the present disclosure, the generation module 32 is specifically configured to process the requirement text by the operation and maintenance processing model, to obtain at least one orderly arranged link node; obtain a corresponding target agent object from agent objects built in the operation and maintenance processing model based on the link node; and generate the task processing link based on the at least one orderly arranged link node and the corresponding target agent object.

According to one or more embodiments of the present disclosure, when obtaining a corresponding target agent object from agent objects built in the operation and maintenance processing model based on the link node, the generation module 32 is specifically configured to determine a corresponding agent function type based on a processing step corresponding to the link node; and obtain, based on the agent function type, the target agent object built in the operation and maintenance processing model.

According to one or more embodiments of the present disclosure, the generation module 32 is specifically configured to process the requirement text by the operation and maintenance processing model, to obtain at least two target agent objects for executing the target operation and maintenance task; and sequentially determine processing steps corresponding to the target operation and maintenance task by the at least two target agent objects, to dynamically generate the task processing link.

According to one or more embodiments of the present disclosure, the at least two target agent objects include a main agent object and at least one functional agent object corresponding to the target operation and maintenance task; and when sequentially determining processing steps corresponding to the target operation and maintenance task by the at least two target agent objects, to dynamically generate the task processing link, the generation module 32 is specifically configured to process input information by the main agent object to obtain a target processing step; invoke a functional agent object corresponding to the target processing step to obtain a step execution result of the target processing step; and set, if the step execution result of the target processing step does not meet an expected result, the step execution result of the target processing step as input information, and return to execute the step of determining a target processing step by the main agent object, or generate, if the step execution result of the target processing step meets the expected result, the task processing link based on a target processing step determined each time.

According to one or more embodiments of the present disclosure, when sequentially determining processing steps corresponding to the target operation and maintenance task by the at least two target agent objects, to dynamically generate the task processing link, the generation module 32 is specifically configured to execute corresponding processing steps by the at least two target agent objects with corresponding execution parameters respectively and output corresponding step execution results; exchange the step execution results between the at least two target agent objects to jointly determine a target processing step; obtain a step execution result corresponding to the target processing step by invoking a target agent object corresponding to the target processing step; and update, if the step execution result corresponding to the target processing step does not meet an expected result, the execution parameter based on the step execution result corresponding to the target processing step, and return to execute the step of executing corresponding processing steps by the at least two target agent objects with corresponding execution parameters respectively and outputting corresponding step execution results, or generate, if the step execution result corresponding to the target processing step meets the expected result, the task processing link based on a target processing step determined each time.

According to one or more embodiments of the present disclosure, the obtaining module 31 is further configured to receive a first user instruction, where the first user instruction is used to set a function implemented by an agent object during execution of a processing step for the target operation and maintenance task; and the generation module 32 is further configured to configure the agent object in the operation and maintenance processing model based on the first user instruction, where the operation and maintenance processing model is used to invoke the configured agent object to generate the task processing link.

According to one or more embodiments of the present disclosure, when configuring the agent object in the operation and maintenance processing model based on the first user instruction, the generation module 32 is specifically configured to obtain a configuration template based on a target format, where the target format corresponds to a training sample of the operation and maintenance processing model; and set the configuration template based on the first user instruction, to generate agent description information, and input the agent description information into the operation and maintenance processing model, to configure the agent object in the operation and maintenance processing model.

According to one or more embodiments of the present disclosure, the obtaining module 31 is further configured to receive a second user instruction, where the second user instruction is used to indicate a step execution result of at least one processing step; and the generation module 32 is further configured to replace a step execution result output by a target agent object corresponding to the processing step based on the step execution result indicated by the second user instruction.

According to one or more embodiments of the present disclosure, the processing module 33 is specifically configured to obtain an execution order corresponding to invoking target agent objects corresponding to link nodes based on the task processing link; and invoke, based on the execution order, the corresponding target agent objects with corresponding execution parameters as inputs in sequence to obtain the execution result of the target operation and maintenance task.

According to one or more embodiments of the present disclosure, the processing module 33 is further configured to detect the execution result, and output the execution result if the execution result conforms to an expected result, or adjust, if the execution result does not conform to the expected result, the task processing link based on the execution result to generate an updated task processing link.

The obtaining module 31, the generation module 32 and the processing module 33 are connected in sequence. The apparatus of task executing 3 in this embodiment may perform the technical solution of the above method embodiment. The implementation principles and technical effects thereof are similar, which are not repeated in this embodiment.

FIG. 16 is a schematic diagram of a structure of an electronic device according to an embodiment of the present disclosure. As shown in FIG. 16, an electronic device 4 includes: a processor 41, and a memory 42 in communicative connection with the processor 41, where the memory 42 stores computer-executable instructions; and the processor 41 executes the computer-executable instructions stored in the memory 42 to implement the method of task executing according to each of the embodiments shown in FIG. 2 to FIG. 14.

Optionally, the processor 41 and the memory 42 are connected by a bus 43.

The related description may be understood with reference to related description and effects that correspond to the steps in the embodiments corresponding to FIG. 2 to FIG. 14. Details are not described herein.

An embodiment of the present disclosure provides a computer-readable storage medium. The computer-readable storage medium stores computer-executable instructions, and the computer-executable instructions, when executed by a processor, are used to implement the method of task executing according to any one of the embodiments corresponding to FIG. 2 to FIG. 14 of the present disclosure.

An embodiment of the present disclosure provides a computer program product, including a computer program that, when executed by a processor, causes the method of task executing according to any one of the embodiments corresponding to FIG. 2 to FIG. 14 of the present disclosure to be implemented.

To implement the above embodiments, an embodiment of the present disclosure further provides an electronic device.

FIG. 17 is a schematic diagram of a structure of an electronic device 900 suitable for implementing the embodiments of the present disclosure. The electronic device 900 may be a terminal device or a server. The terminal device may include, but is not limited to, a mobile terminal such as a mobile phone, a notebook computer, a digital broadcast receiver, a personal digital assistant (PDA), a tablet computer (portable Android device (PAD)), a portable media player (PMP), and a vehicle-mounted terminal (such as a vehicle navigation terminal), and a fixed terminal such as a digital TV and a desktop computer. The electronic device shown in FIG. 17 is merely an example, and shall not impose any limitation on the functions and use scope of the embodiments of the present disclosure.

As shown in FIG. 17, the electronic device 900 may include a processing apparatus (e.g., a central processing unit or a graphics processing unit) 901 that may perform a variety of appropriate actions and processing in accordance with a program stored in a read-only memory (ROM) 902 or a program loaded from a storage apparatus 908 into a random access memory (RAM) 903. The RAM 903 further stores various programs and data required for operations of the electronic device 900. The processing apparatus 901, the ROM 902, and the RAM 903 are connected to each other through a bus 904. An input/output (I/O) interface 905 is also connected to the bus 904.

Generally, the following apparatuses may be connected to the I/O interface 905: an input apparatus 906 including, for example, a touchscreen, a touchpad, a keyboard, a mouse, a camera, a microphone, an accelerometer, and a gyroscope; an output apparatus 907 including, for example, a liquid crystal display (LCD), a speaker, and a vibrator; the storage apparatus 908 including, for example, a tape and a hard disk; and a communication apparatus 909. The communication apparatus 909 may allow the electronic device 900 to perform wireless or wired communication with other devices to exchange data. Although FIG. 17 shows the electronic device 900 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded from a network by the communication apparatus 909 and installed, installed from the storage apparatus 908, or installed from the ROM 902. When the computer program is executed by the processing apparatus 901, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to perform the method shown in the above embodiment.

The computer program code for performing the operations in the present disclosure may be written in one or more programming languages or a combination thereof, where the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user via any kind of network, including a local area network (LAN) or a wide area network (WAN), or may be connected to an external computer (for example, connected via the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units or modules described in the embodiments of the present disclosure may be implemented by software, or may be implemented by hardware. The name of the unit or module does not constitute a limitation on the unit itself under certain circumstances.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, a method of task executing is provided, including: obtaining requirement text based on a natural language, where the requirement text is used to describe a target operation and maintenance task; processing the requirement text by an operation and maintenance processing model, to generate a task processing link, which provides at least one link node and a corresponding agent object, where the link node is used to represent a processing step for the target operation and maintenance task, and the agent object is used to execute a processing step represented by the corresponding link node; and executing the task processing link, to generate a task execution result of the target operation and maintenance task.

According to one or more embodiments of the present disclosure, the processing the requirement text by an operation and maintenance processing model, to generate a task processing link includes: performing intent recognition on the requirement text by the operation and maintenance processing model, to obtain type information representing a task type of the target operation and maintenance task; performing retrieval on preset task processing links in the operation and maintenance processing model based on the type information; and if there is a hit, obtaining a first task processing link of a target task type corresponding to the type information from the preset task processing links, or if there is no hit, performing chain-of-thought reasoning on the requirement text based on the operation and maintenance processing model, to generate a second task processing link of the target task type corresponding to the type information.

According to one or more embodiments of the present disclosure, the method further includes: performing intent recognition on the requirement text by the operation and maintenance processing model, to obtain node information corresponding to at least one target link node, where the target link node is a link node in the first task processing link or the second task processing link, and the node information is used to represent an execution parameter of a processing step corresponding to the target link node; and configuring the first task processing link or the second task processing link based on the node information, to generate the task processing link.

According to one or more embodiments of the present disclosure, the processing the requirement text by an operation and maintenance processing model, to generate a task processing link includes: processing the requirement text by the operation and maintenance processing model, to obtain at least one orderly arranged link node; obtaining a corresponding target agent object from agent objects built in the operation and maintenance processing model based on the link node; and generating the task processing link based on the at least one orderly arranged link node and the corresponding target agent object.

According to one or more embodiments of the present disclosure, the obtaining a corresponding target agent object from agent objects built in the operation and maintenance processing model based on the link node includes: determining a corresponding agent function type based on a processing step corresponding to the link node; and obtaining, based on the agent function type, the target agent object built in the operation and maintenance processing model.

According to one or more embodiments of the present disclosure, the processing the requirement text by an operation and maintenance processing model, to generate a task processing link includes: processing the requirement text by the operation and maintenance processing model, to obtain at least two target agent objects for executing the target operation and maintenance task; and sequentially determining processing steps corresponding to the target operation and maintenance task by the at least two target agent objects, to dynamically generate the task processing link.

According to one or more embodiments of the present disclosure, the at least two target agent objects include a main agent object and at least one functional agent object corresponding to the target operation and maintenance task; and the sequentially determining processing steps corresponding to the target operation and maintenance task by the at least two target agent objects, to dynamically generate the task processing link includes: processing input information by the main agent object to obtain a target processing step; invoking a functional agent object corresponding to the target processing step to obtain a step execution result of the target processing step; and if the step execution result of the target processing step does not meet an expected result, setting the step execution result of the target processing step as input information, and returning to execute the step of determining a target processing step by the main agent object, or if the step execution result of the target processing step meets the expected result, generating the task processing link based on a target processing step determined each time.

According to one or more embodiments of the present disclosure, the sequentially determining processing steps corresponding to the target operation and maintenance task by the at least two target agent objects, to dynamically generate the task processing link includes: executing corresponding processing steps by the at least two target agent objects with corresponding execution parameters respectively and outputting corresponding step execution results; exchanging the step execution results between the at least two target agent objects to jointly determine a target processing step; obtaining a step execution result corresponding to the target processing step by invoking a target agent object corresponding to the target processing step; and if the step execution result corresponding to the target processing step does not meet an expected result, updating the execution parameter based on the step execution result corresponding to the target processing step, and returning to execute the step of executing corresponding processing steps by the at least two target agent objects with corresponding execution parameters respectively and outputting corresponding step execution results, or if the step execution result corresponding to the target processing step meets the expected result, generating the task processing link based on a target processing step determined each time.

According to one or more embodiments of the present disclosure, the method further includes: receiving a first user instruction, where the first user instruction is used to set a function implemented by an agent object during execution of a processing step for the target operation and maintenance task; and configuring the agent object in the operation and maintenance processing model based on the first user instruction, where the operation and maintenance processing model is used to invoke the configured agent object to generate the task processing link.

According to one or more embodiments of the present disclosure, the configuring the agent object in the operation and maintenance processing model based on the first user instruction includes: obtaining a configuration template based on a target format, where the target format corresponds to a training sample of the operation and maintenance processing model; and setting the configuration template based on the first user instruction, to generate agent description information, and inputting the agent description information into the operation and maintenance processing model, to configure the agent object in the operation and maintenance processing model.

According to one or more embodiments of the present disclosure, the method further includes: receiving a second user instruction, where the second user instruction is used to indicate a step execution result of at least one processing step; and replacing a step execution result output by a target agent object corresponding to the processing step based on the step execution result indicated by the second user instruction.

According to one or more embodiments of the present disclosure, the executing the task processing link, to generate an execution result of the target operation and maintenance task includes: obtaining an execution order corresponding to invoking target agent objects corresponding to link nodes based on the task processing link; and based on the execution order, invoking the corresponding target agent objects with corresponding execution parameters as inputs in sequence to obtain the execution result of the target operation and maintenance task.

According to one or more embodiments of the present disclosure, the method further includes: detecting the execution result, and if the execution result conforms to an expected result, outputting the execution result, or if the execution result does not conform to the expected result, adjusting the task processing link based on the execution result to generate an updated task processing link.

According to one or more embodiments of the present disclosure, an apparatus of task executing is provided, including: an obtaining module, configured to obtain a requirement text based on natural language, where the requirement text is used to describe a target operation and maintenance task; a generation module, configured to process the requirement text by an operation and maintenance processing model, to generate a task processing link, which provides at least one link node and a corresponding agent object, where the link node is used to represent a processing step for the target operation and maintenance task, and the agent object is used to execute a processing step represented by the corresponding link node; and a processing module, configured to execute the task processing link, to generate a task execution result of the target operation and maintenance task.

According to one or more embodiments of the present disclosure, the generation module is specifically configured to perform intent recognition on the requirement text by the operation and maintenance processing model, to obtain type information representing a task type of the target operation and maintenance task; perform retrieval on preset task processing links in the operation and maintenance processing model based on the type information; and obtain, if there is a hit, a first task processing link of a target task type corresponding to the type information from the preset task processing links, or perform, if there is no hit, chain-of-thought reasoning on the requirement text based on the operation and maintenance processing model, to generate a second task processing link of the target task type corresponding to the type information.

According to one or more embodiments of the present disclosure, the generation module is further configured to perform intent recognition on the requirement text by the operation and maintenance processing model, to obtain node information corresponding to at least one target link node, where the target link node is a link node in the first task processing link or the second task processing link, and the node information is used to represent an execution parameter of a processing step corresponding to the target link node; and configure the first task processing link or the second task processing link based on the node information, to generate the task processing link.

According to one or more embodiments of the present disclosure, the generation module is specifically configured to process the requirement text by the operation and maintenance processing model, to obtain at least one orderly arranged link node; obtain a corresponding target agent object from agent objects built in the operation and maintenance processing model based on the link node; and generate the task processing link based on the at least one orderly arranged link node and the corresponding target agent object.

According to one or more embodiments of the present disclosure, when obtaining a corresponding target agent object from agent objects built in the operation and maintenance processing model based on the link node, the generation module is specifically configured to determine a corresponding agent function type based on a processing step corresponding to the link node; and obtain, based on the agent function type, the target agent object built in the operation and maintenance processing model.

According to one or more embodiments of the present disclosure, the generation module is specifically configured to process the requirement text by the operation and maintenance processing model, to obtain at least two target agent objects for executing the target operation and maintenance task; and sequentially determine processing steps corresponding to the target operation and maintenance task by the at least two target agent objects, to dynamically generate the task processing link.

According to one or more embodiments of the present disclosure, the at least two target agent objects include a main agent object and at least one functional agent object corresponding to the target operation and maintenance task; and when sequentially determining processing steps corresponding to the target operation and maintenance task by the at least two target agent objects, to dynamically generate the task processing link, the generation module is specifically configured to process input information by the main agent object to obtain a target processing step; invoke a functional agent object corresponding to the target processing step to obtain a step execution result of the target processing step; and set, if the step execution result of the target processing step does not meet an expected result, the step execution result of the target processing step as input information, and return to execute the step of determining a target processing step by the main agent object, or generate, if the step execution result of the target processing step meets the expected result, the task processing link based on a target processing step determined each time.

According to one or more embodiments of the present disclosure, when sequentially determining processing steps corresponding to the target operation and maintenance task by the at least two target agent objects, to dynamically generate the task processing link, the generation module is specifically configured to execute corresponding processing steps by the at least two target agent objects with corresponding execution parameters respectively and output corresponding step execution results; exchange the step execution results between the at least two target agent objects to jointly determine a target processing step; obtain a step execution result corresponding to the target processing step by invoking a target agent object corresponding to the target processing step; and update, if the step execution result corresponding to the target processing step does not meet an expected result, the execution parameter based on the step execution result corresponding to the target processing step, and return to execute the step of executing corresponding processing steps by the at least two target agent objects with corresponding execution parameters respectively and outputting corresponding step execution results, or generate, if the step execution result corresponding to the target processing step meets the expected result, the task processing link based on a target processing step determined each time.

According to one or more embodiments of the present disclosure, the obtaining module is further configured to receive a first user instruction, where the first user instruction is used to set a function implemented by an agent object during execution of a processing step for the target operation and maintenance task; and the generation module is further configured to configure the agent object in the operation and maintenance processing model based on the first user instruction, where the operation and maintenance processing model is used to invoke the configured agent object to generate the task processing link.

According to one or more embodiments of the present disclosure, when configuring the agent object in the operation and maintenance processing model based on the first user instruction, the generation module is specifically configured to obtain a configuration template based on a target format, where the target format corresponds to a training sample of the operation and maintenance processing model; and set the configuration template based on the first user instruction, to generate agent description information, and input the agent description information into the operation and maintenance processing model, to configure the agent object in the operation and maintenance processing model.

According to one or more embodiments of the present disclosure, the obtaining module is further configured to receive a second user instruction, where the second user instruction is used to indicate a step execution result of at least one processing step; and the generation module is further configured to replace a step execution result output by a target agent object corresponding to the processing step based on the step execution result indicated by the second user instruction.

According to one or more embodiments of the present disclosure, the processing module is specifically configured to obtain an execution order corresponding to invoking target agent objects corresponding to link nodes based on the task processing link; and invoke, based on the execution order, the corresponding target agent objects with corresponding execution parameters as inputs in sequence to obtain the execution result of the target operation and maintenance task.

According to one or more embodiments of the present disclosure, the processing module is further configured to detect the execution result, and output the execution result if the execution result conforms to an expected result, or adjust, if the execution result does not conform to the expected result, the task processing link based on the execution result to generate an updated task processing link.

According to one or more embodiments of the present disclosure, an electronic device is provided, including: at least one processor and a memory, where the memory stores computer-executable instructions; and the at least one processor executes the computer-executable instructions stored in the memory, to cause the at least one processor to perform the method of task executing according to the above and various possible designs of the above.

According to one or more embodiments of the present disclosure, a computer-readable storage medium is provided. The computer-readable storage medium stores computer-executable instructions that, when executed by a processor, cause the method of task executing according to the above and various possible designs of the above described above to be implemented.

According to one or more embodiments of the present disclosure, a computer program product including a computer program is provided. The computer program, when executed by a processor, causes the method of task executing according to the above and various possible designs of the above described above to be implemented.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A method of task executing, comprising:
obtaining a requirement text based on natural language, wherein the requirement text is used to describe a target operation and maintenance task;
processing the requirement text by an operation and maintenance processing model, to generate a task processing link, which provides at least one link node and a corresponding agent object, wherein the link node is used to represent a processing step for the target operation and maintenance task, and the agent object is used to execute a processing step represented by the corresponding link node, the operation and maintenance processing model supports natural language-based interaction, so as to execute a natural language processing task, and supports scheduling of one or more of a plurality of agent objects pre-configured in an operation and maintenance scenario based on the task, so as to control the scheduled agent objects to cooperatively complete a task instruction; and
executing the task processing link, to generate a task execution result of the target operation and maintenance task.

2. The method according to claim 1, wherein the processing the requirement text by an operation and maintenance processing model, to generate a task processing link comprises:
performing intent recognition on the requirement text by the operation and maintenance processing model, to obtain type information representing a task type of the target operation and maintenance task;
performing retrieval on preset task processing links in the operation and maintenance processing model based on the type information; and
if there is a hit, obtaining a first task processing link of a target task type corresponding to the type information from the preset task processing links, or
if there is no hit, performing chain-of-thought reasoning on the requirement text based on the operation and maintenance processing model, to generate a second task processing link of the target task type corresponding to the type information.

3. The method according to claim 2, further comprising:
performing intent recognition on the requirement text by the operation and maintenance processing model, to obtain node information corresponding to at least one target link node, wherein the target link node is a link node in the first task processing link or the second task processing link, and the node information is used to represent an execution parameter of a processing step corresponding to the target link node; and
configuring the first task processing link or the second task processing link based on the node information, to generate the task processing link.

4. The method according to claim 1, wherein the processing the requirement text by an operation and maintenance processing model, to generate a task processing link comprises:
processing the requirement text by the operation and maintenance processing model, to obtain at least one orderly arranged link node;
obtaining a corresponding target agent object from agent objects built in the operation and maintenance processing model based on the link node; and
generating the task processing link based on the at least one orderly arranged link node and the corresponding target agent object.

5. The method according to claim 4, wherein the obtaining a corresponding target agent object from agent objects built in the operation and maintenance processing model based on the link node comprises:
determining a corresponding agent function type based on a processing step corresponding to the link node; and
obtaining the target agent object built in the operation and maintenance processing model based on the agent function type.

6. The method according to claim 1, wherein the processing the requirement text by an operation and maintenance processing model, to generate a task processing link comprises:
processing the requirement text by the operation and maintenance processing model, to obtain at least two target agent objects for executing the target operation and maintenance task; and
sequentially determining processing steps corresponding to the target operation and maintenance task by the at least two target agent objects, to dynamically generate the task processing link.

7. The method according to claim 6, wherein the at least two target agent objects comprise a main agent object and at least one functional agent object corresponding to the target operation and maintenance task; and the sequentially determining processing steps corresponding to the target operation and maintenance task by the at least two target agent objects, to dynamically generate the task processing link comprises:
outputting a target processing step by the main agent object;
invoking a functional agent object corresponding to the target processing step, to obtain a step execution result of the target processing step; and
if the step execution result of the target processing step does not meet an expected result, setting the step execution result of the target processing step as input information, and returning to execute the step of determining a target processing step by the main agent object based on the input information, or if the step execution result of the target processing step meets the expected result, generating the task processing link based on a target processing step determined each time.

8. The method according to claim 6, wherein the sequentially determining processing steps corresponding to the target operation and maintenance task by the at least two target agent objects, to dynamically generate the task processing link comprises:
executing corresponding processing steps by the at least two target agent objects with corresponding execution parameters respectively, and outputting corresponding step execution results;
exchanging the step execution results between the at least two target agent objects, to jointly determine a target processing step;
obtaining a step execution result corresponding to the target processing step by invoking a target agent object corresponding to the target processing step; and
if the step execution result corresponding to the target processing step does not meet an expected result, updating the execution parameter based on the step execution result corresponding to the target processing step, and returning to execute the step of executing corresponding processing steps by the at least two target agent objects with corresponding execution parameters respectively, and outputting corresponding step execution results, or if the step execution result corresponding to the target processing step meets the expected result, generating the task processing link based on a target processing step determined each time.

9. The method according to claim 6, further comprising:
during the process of sequentially determining processing steps corresponding to the target operation and maintenance task by the at least two target agent objects, receiving a second user instruction, wherein the second user instruction is used to indicate a step execution result of at least one processing step; and
replacing a step execution result output by a target agent object corresponding to the processing step based on the step execution result indicated by the second user instruction.

10. The method according to claim 1, further comprising:
receiving a first user instruction, wherein the first user instruction is used to set a function implemented by an agent object during execution of a processing step for the target operation and maintenance task; and
configuring the agent object in the operation and maintenance processing model based on the first user instruction, wherein the operation and maintenance processing model is used to invoke the configured agent object to generate the task processing link.

11. The method according to claim 10, wherein the configuring the agent object in the operation and maintenance processing model based on the first user instruction comprises:
obtaining a configuration template based on a target format, wherein the target format corresponds to a training sample of the operation and maintenance processing model; and
setting the configuration template based on the first user instruction, to generate agent description information, and inputting the agent description information into the operation and maintenance processing model, to configure the agent object in the operation and maintenance processing model.

12. The method according to claim 1, wherein the executing the task processing link, to generate an execution result of the target operation and maintenance task comprises:
obtaining an execution order corresponding to invoking target agent objects corresponding to link nodes based on the task processing link; and
invoking the corresponding target agent objects with corresponding execution parameters as inputs in sequence based on the execution order, to obtain the execution result of the target operation and maintenance task.

13. The method according to claim 1, further comprising:
detecting the execution result, and if the execution result conforms to an expected result, outputting the execution result, or if the execution result does not conform to the expected result, generating an updated task processing link based on the execution result.

14. An electronic device, comprising: at least one processor and at least one memory, wherein
the at least one memory stores computer-executable instructions; and
the at least one processor executes the computer-executable instructions stored in the at least one memory, to cause the at least one processor to perform a method of task executing, which comprises:
obtaining a requirement text based on natural language, wherein the requirement text is used to describe a target operation and maintenance task;
processing the requirement text by an operation and maintenance processing model, to generate a task processing link, which provides at least one link node and a corresponding agent object, wherein the link node is used to represent a processing step for the target operation and maintenance task, and the agent object is used to execute a processing step represented by the corresponding link node, the operation and maintenance processing model supports natural language-based interaction, so as to execute a natural language processing task, and supports scheduling of one or more of a plurality of agent objects pre-configured in an operation and maintenance scenario based on the task, so as to control the scheduled agent objects to cooperatively complete a task instruction; and
executing the task processing link, to generate a task execution result of the target operation and maintenance task.

15. The electronic device according to claim 14, wherein the processing the requirement text by an operation and maintenance processing model, to generate a task processing link comprises:
performing intent recognition on the requirement text by the operation and maintenance processing model, to obtain type information representing a task type of the target operation and maintenance task;
performing retrieval on preset task processing links in the operation and maintenance processing model based on the type information; and
if there is a hit, obtaining a first task processing link of a target task type corresponding to the type information from the preset task processing links, or
if there is no hit, performing chain-of-thought reasoning on the requirement text based on the operation and maintenance processing model, to generate a second task processing link of the target task type corresponding to the type information.

16. The electronic device according to claim 15, further comprising:
performing intent recognition on the requirement text by the operation and maintenance processing model, to obtain node information corresponding to at least one target link node, wherein the target link node is a link node in the first task processing link or the second task processing link, and the node information is used to represent an execution parameter of a processing step corresponding to the target link node; and
configuring the first task processing link or the second task processing link based on the node information, to generate the task processing link.

17. The electronic device according to claim 14, wherein the processing the requirement text by an operation and maintenance processing model, to generate a task processing link comprises:
processing the requirement text by the operation and maintenance processing model, to obtain at least one orderly arranged link node;
obtaining a corresponding target agent object from agent objects built in the operation and maintenance processing model based on the link node; and
generating the task processing link based on the at least one orderly arranged link node and the corresponding target agent object.

18. The electronic device according to claim 17, wherein the obtaining a corresponding target agent object from agent objects built in the operation and maintenance processing model based on the link node comprises:
determining a corresponding agent function type based on a processing step corresponding to the link node; and
obtaining the target agent object built in the operation and maintenance processing model based on the agent function type.

19. The electronic device according to claim 14, wherein the processing the requirement text by an operation and maintenance processing model, to generate a task processing link comprises:
processing the requirement text by the operation and maintenance processing model, to obtain at least two target agent objects for executing the target operation and maintenance task; and
sequentially determining processing steps corresponding to the target operation and maintenance task by the at least two target agent objects, to dynamically generate the task processing link.

20. A non-transient computer-readable storage medium, storing computer-executable instructions that, when executed by a processor, cause a method of task executing, which comprises:
obtaining a requirement text based on natural language, wherein the requirement text is used to describe a target operation and maintenance task;
processing the requirement text by an operation and maintenance processing model, to generate a task processing link, which provides at least one link node and a corresponding agent object, wherein the link node is used to represent a processing step for the target operation and maintenance task, and the agent object is used to execute a processing step represented by the corresponding link node, the operation and maintenance processing model supports natural language-based interaction, so as to execute a natural language processing task, and supports scheduling of one or more of a plurality of agent objects pre-configured in an operation and maintenance scenario based on the task, so as to control the scheduled agent objects to cooperatively complete a task instruction; and
executing the task processing link, to generate a task execution result of the target operation and maintenance task.
